(19) United States
(12) Patent Application Publication
(10) Pub. No.: US 2003/0142661 A1
(43) Pub. Date: Jul. 31, 2003

(54) System and method for distributing data between a telephone network and an entertainment network

(76) Inventor: Masayuki Chatani, Sunnyvale, CA (US)

Correspondence Address: CARR & FERRELL LLP, 2225 EAST BAYSHORE ROAD, SUITE 200, PALO ALTO, CA, 94303, US

(21) Appl. No.: 10/059,837

(22) Filed: Jan. 28, 2002

(51) Int. Cl. H04L 12/66; H04L 12/56

(52) U.S. Cl. 370/352; 370/401

(57) ABSTRACT

A system and method for distributing data between telephone devices and electronic entertainment systems. The data may be voice data or image data. The system includes a plurality of telephone devices, a plurality of entertainment systems, a conversion server, a user management server, a user database, and a game server. Analog phone data received by the conversion server from the telephone devices via a telephone network is converted to digital data including a user identification. A user name associated with the user identification is determined, target users are identified, and the data is distributed to the target users' entertainment system. In addition, entertainment system data is distributed to telephone devices of target users when game situations specified by the users are realized.

### BACKGROUND OF THE INVENTION

1. Field of the Invention

This invention relates generally to electronic data distribution and more particularly to the distribution of data between a telephone network and an entertainment network.

2. Description of the Background Art

A multi-user interactive electronic entertainment system typically communicates via local area networks (LANS) to allow multiple users to participate simultaneously in electronic games. Typically, the users of the interactive entertainment systems are constrained to play the games in close proximity to other users, limited by physical restrictions imposed by LAN architecture. In addition, each user of an interactive electronic entertainment system must be logged onto the system to participate in a game and to react to particular game situations. Generally, each user collects virtual reality world game information via the user's entertainment system monitor, where such information is typically limited to visual information obtained through each user's game character. Consequently, game information is distributed to active participants of multi-user interactive electronic games and is limited to information gathered via each user's game character.

It would be advantageous to users of interactive electronic entertainment systems to distribute data from a telephone device to a plurality of target entertainment system users, where the target users may be specified by either the user of the telephone device or by a server dedicated to monitoring the entertainment systems. Such a system would allow users to target other users based on a variety of dynamic, time-varying factors to enhance interactive game experiences. In addition, it would be advantageous to enable a user who is not logged onto an interactive game to send data via a telephone device to other targeted users. These targeted users may have relationships with the user's game character, friendly, hostile or otherwise. In this manner, the user can still be involved in the game, even when the user is not logged onto the game as an active participant.

In addition, it would be advantageous to distribute entertainment system game data to a plurality of targeted telephone device users, where the users may be targeted in a dynamic fashion, based upon game situations. In this manner, a user may be contacted via a telephone device when the user's character achieves game goals or when the user's character is placed in specific game situations by other users' characters.

### SUMMARY OF THE INVENTION

The present invention provides a system and method for distributing data between telephone devices and electronic entertainment systems. The data may include voice data and image data. The system includes a plurality of telephone devices, a plurality of entertainment systems, a conversion server, a user management server, a user database, and a game server.

In one embodiment of the invention, the conversion server receives analog phone data from the telephone devices via a telephone network, and converts the analog data to digital data and inserts a user identification in the header of the digital data. The user identification includes a user ID and a user telephone number. The conversion server routes the digital data to the user management server. The user management server accesses the database to determine a user name associated with the user identification received in the header of the digital data. The user server then sends a distribution request signal including the user name to the game server. In response to the distribution request signal, the game server sends target user names associated with the user name. The target user names associated with the user name may have been selected by the game server or selected by the user of the entertainment system. Selection criteria include (1) choosing any user from the user's entertainment system or choosing any user from a menu panel on the user's entertainment system, (2) choosing users whose avatars are within a specified distance of the user's avatar, or (3) choosing users whose avatars have a relationship with the user's avatar. Once the target user names are received by the user server, the user server sends the digital data to the users' entertainment systems that are associated with the target user names. In another embodiment of the invention, the user server prepares a distribution list, including the target user names, and sends the list and the digital data to the game server. The game server then sends the digital data to those users' entertainment systems that are associated with the target user names.

In another embodiment of the invention, the game server monitors the entertainment systems for game situations specified by the users of the entertainment systems. If the game server detects that a game situation is realized for a particular user of an entertainment system, then the game server receives the entertainment system data and the target user names from the entertainment system. The game server routes the entertainment system data and the names of the target users to the user server. The user server accesses the user database, determines the telephone numbers of the target user names, and sends the target user telephone numbers and the entertainment system data to the conversion server. The conversion server converts the entertainment system data to analog entertainment system data and sends the analog data to those user devices associated with the target user telephone numbers.

### BRIEF DESCRIPTION OF THE DRAWINGS

FIG. 1 is a block diagram of one embodiment of a networked electronic entertainment system, according to the invention;

FIG. 2 is a flowchart of method steps for distributing data from a telephone device to the entertainment systems, according to the invention;

FIG. 3 is a flowchart of method steps for distributing data from an entertainment system to the telephone devices, according to the invention; and

FIG. 4 is a block diagram of another embodiment of a networked electronic entertainment system, according to the invention.

### DETAILED DESCRIPTION OF THE DRAWINGS

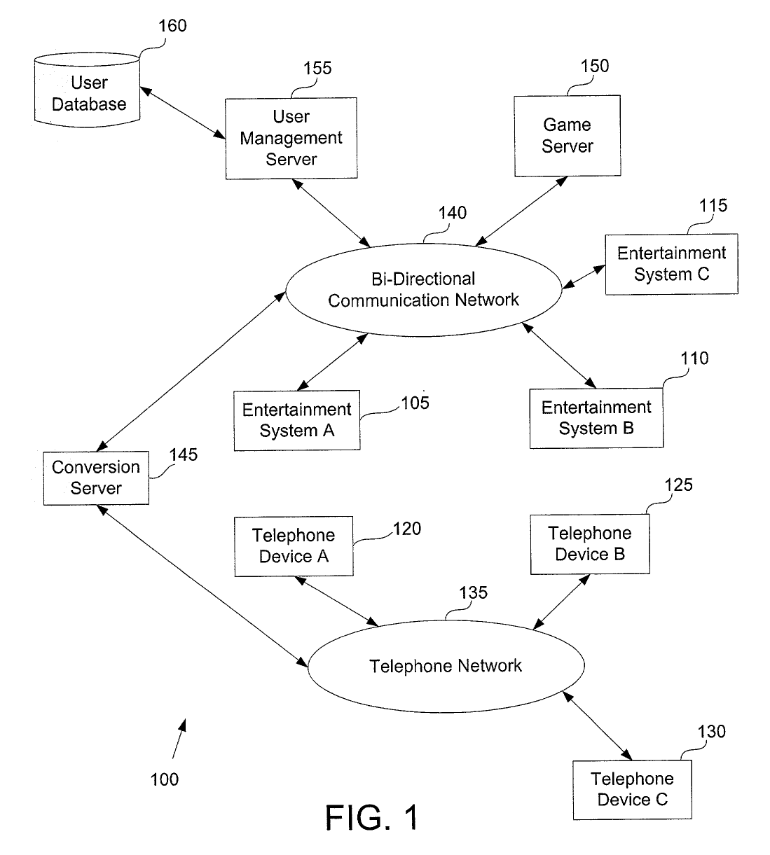

FIG. 1 is a block diagram of one embodiment of a networked electronic entertainment system 100 in accordance with the invention. System 100 includes, but is not limited to, a plurality of entertainment systems including an entertainment system A 105, an entertainment system B 110, and an entertainment system C 115, a plurality of telephone devices including a telephone device A 120, a telephone device B 125, and a telephone device C 130, a telephone network 135, a bi-directional communication network 140, a conversion server 145, a game server 150, a user management server 155, and a user database 160.

The entertainment systems may be electronic entertainment systems, such as a gaming console, or other game systems stored on computer readable media and executed by entertainment consoles, PCs, or workstations. The entertainment systems are connected to bi-directional communication network 140. Bi-directional communication network 140 may be an analog telephone network, a DSL network, a cable network, or a fixed or mobile wireless network that enables the entertainment systems to communicate with game server 150, user management server 155, and conversion server 145.

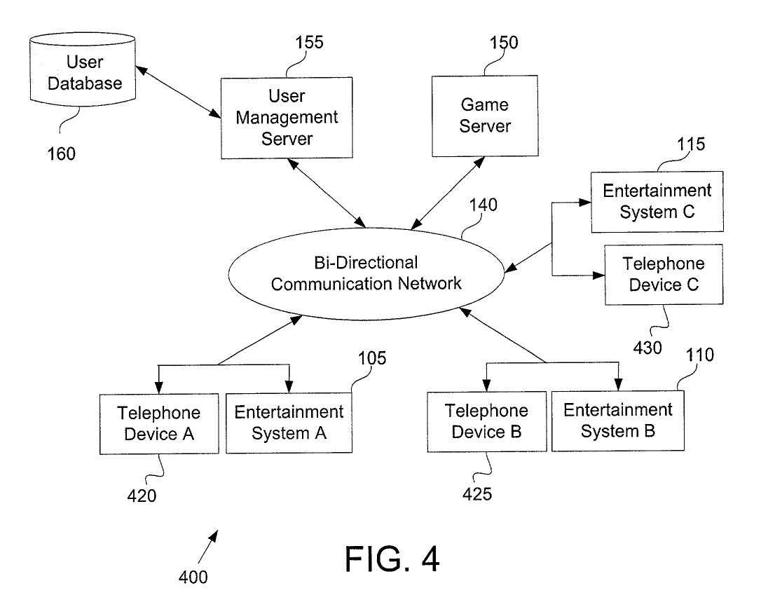

In addition, the user of each entertainment system has access to a telephone device, such as a cellular phone. For example, the user of entertainment system A 105 is the user of telephone device A 120, and the user of entertainment system C 115 is the user of telephone device C 130. The telephone devices are connected to telephone network 135, which in one embodiment is an analog cellular telephone network. Typically, telephone network 135 and communication network 140 are different physical networks. However, voice and entertainment system data may be transmitted via a common, shared physical network. The distribution of voice and entertainment system data over networked entertainment system 100 via a common physical network will be discussed further below in conjunction with FIG. 4.

Conversion server 145 connects telephone network 135 to communication network 140, enabling communication between, for example, telephone device A 120 and entertainment system B 110. Conversion server 145 receives analog data from telephone network 135, digitizes the received analog data, and sends the digital data to communication network 140 for distribution to the entertainment systems. Likewise, conversion server 145 receives digital data from communication network 140, converts the received digital data to analog data, and sends the analog data to telephone network 135 for distribution to the telephone devices. The scope of the present invention covers all data types, including voice signals and image data. If the digital data is a voice signal, then conversion server 145 converts the digital voice signal to an analog voice signal via a speech synthesizer or other conversion means.

Game server 150 is an application server that provides services to the entertainment systems. For example, game server 150 hosts a virtual reality world application for a multi-user game played by a plurality of users on a plurality of entertainment systems. Game server 150 includes a memory for storage of game information and data, such as user names and user game status.

User management server 155 connects communication network 140 to user database 160. User management server 155 manages user database 160 upon receiving signals from communication network 140. User data is stored in user database 160, and includes data fields for a user's personal data, such as user name, user address, user device information, and user purchase history. A user's devices include entertainment systems, telephone devices, or other devices that are owned by a user and connected to user management server 155 via communication network 140 or telephone network 135. For example, when a user A (not shown) connects entertainment system A 105 and telephone device A 120 to user management server 155 for the first time, user management server 155 assigns a user ID to entertainment system A 105 and telephone device A 120, and then stores user A's name, address, and device information, such as user ID and device telephone number, for example, in the corresponding data fields in user database 160. Alternatively, instead of assigning a user ID, user management server 155 may assign device IDs to entertainment system A 105 and telephone device A 120, and then store the device IDs and the device telephone number in the user device information data field in user database 160.

In addition, user management server 155 stores user A's purchase information in user A's purchase history data field in user database 160. Purchase information includes device purchase dates and device model information. User management server 155 updates user A's purchase history data field in user database 160 as newly purchased devices are connected with user management server 155.

According to the invention, a user may distribute data such as voice signals or image data from a telephone device to the networked entertainment system 100. The invention allows the user to send data to other users who are using their entertainment systems, even when the user is away from his/her entertainment system. A user may send voice signals and image data from a telephone device to other users' entertainment systems to inform the other users of the user's game status or to provide the other users with game information.

Both game server 150 and the user of a telephone device may specify other users for receiving voice signals or image data. For example, in one embodiment of the invention, a user of a telephone device and corresponding entertainment system may choose to distribute a voice signal or image data to (1) a target entertainment system user, (2) a target entertainment system user and other entertainment system users whose avatars are within a specified range of the user's avatar, or (3) other entertainment system users whose avatars have relationships with the user's avatar or whose avatars have attributes which match attributes specified by the user, where an avatar is a graphical icon representing the user in a virtual reality world managed by game server 150. For instance, relationships may be defined between members that belong to the same team or group. Attributes of each user or each user's avatar may include gender, age, birthplace, occupation, or name, for example. The user may choose target users by selecting the target users' avatars on the user's entertainment system or by selecting target user names or target selection buttons from a menu panel on the user's entertainment system.

In another embodiment of the invention, game server 150 may be enabled to automatically target other users for receiving data from a given user based upon the above-mentioned techniques.

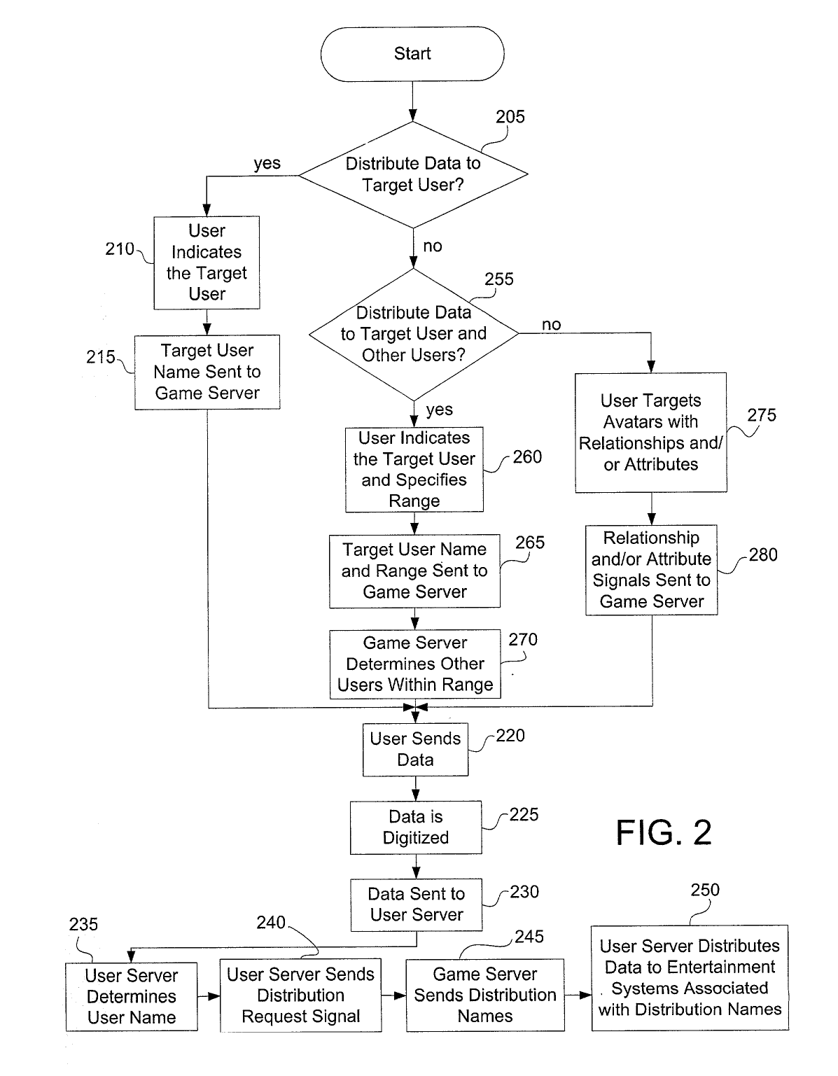

FIG. 2 is a flowchart of steps for distributing data from a telephone device to the entertainment systems, in accordance with one embodiment of the invention. First, in step 205, a user decides whether to distribute data to a target user of an entertainment system. If the user decides to distribute the data to the target user, then in step 210, the user indicates to the networked electronic entertainment system 100 that the data is being sent to the target user by selecting the target user on the user's entertainment system. For example, the user may choose the target user by selecting the target user's avatar on the user's entertainment system. Alternatively, the user may choose the target user by selecting the target user name from a menu panel on the user's entertainment system. In step 215, the user's entertainment system sends the target user name to game server 150 via communication network 140 and game server 150 stores the target user name in association with the user name in memory. The target user name and other user names that are stored in association with the user name are collectively referred to as distribution names. In another embodiment of the invention, steps 210-215 are omitted and the method continues with step 220. In this other embodiment, target users associated with the user are stored in memory of game server 150 upon initialization of the user's entertainment system by the user or system administrator. In step 220, the user sends the data from the user's telephone device to conversion server 145 via telephone network 135. In step 225, the data is received and digitized by conversion server 145. Typically, conversion server 145 inserts an identification that is associated with the user's telephone device in the header of the digital data. For example, conversion server 145 may be enabled with a caller ID function. In this embodiment, conversion server 145 identifies the telephone number of the user's telephone device and inserts the telephone number in the header of the digital data. In another embodiment, the user of an entertainment system identified by a user ID accesses conversion server 145 via communication network 140. Then the user sends the voice signal or image data from the user's telephone device to conversion server 145 via telephone network 135. Conversion server 145 digitizes the data and inserts the user ID into the header of the digital data. In step 230, conversion server 145 sends the digital data to user management server 155 via communication network 140. In step 235, user server 155 accesses user database 160 and determines a user name based on the user ID received in the digital data header. In step 240, user server 155 sends a distribution request signal to game server 150, requesting distribution names associated with the user name. In step 245, game server 150 sends user server 155 the distribution names stored in memory of game server 150 in association with the user name. Finally, in step 250, user server 155 broadcasts the digital data to the entertainment systems corresponding to the distribution names. In another embodiment of the invention, user server 155 prepares a distribution list including the distribution names and sends the distribution list to game server 150. Game server 150 then broadcasts the digital data to the entertainment systems corresponding to the distribution names on the distribution list. If the digital data is a digital voice signal, then each targeted entertainment system, using a speech synthesizer or other means of speech conversion, converts the digital voice signal to an analog voice signal and plays the analog voice signal.

If, in step 205, the user chooses not to distribute the data to the target user, then in step 255 the user decides whether to distribute the data to the target user and other users whose avatars are within the specified range of the user's avatar. If the user decides to distribute the data to the target user and other users whose avatars are within the specified range of the user's avatar, then in step 260 the user indicates to the networked electronic entertainment system 100 that the data is being sent to the target user by selecting the target user on the user's entertainment system. In addition, the user indicates that the data is being sent to other users whose avatars are within the specified range of the user's avatar by selecting, for example, a range button on the user's entertainment system. For example, by selecting a 1 KM range button, the user indicates that the data is being sent to all users whose avatars are within 1 KM of the user's avatar in the virtual world of the game. In step 265, the target user name and the specified range are sent to game server 150 via communication network 140. In another embodiment of the invention, the specified range is predefined upon initialization of the user's entertainment system by the user or the system administrator, and is stored in memory of game server 150. In step 270, game server 150 receives the target user name and the specified range from the user's entertainment system via communication network 140, and using the specified range, determines which other users' avatars are within the specified range of the user's avatar. Game server 150 then stores in association with the user name, in memory of game server 150, the target user name and the other user names corresponding to the other users' avatars located within the specified range. The target user name and the other user names are collectively referred to as distribution names. Finally, the distribution of the data to the entertainment systems associated with the distribution names is completed in steps 220-250 as described above.

If, in step 255, the user decides not to distribute the data to the target user and other users whose avatars are within the specified range of the user's avatar, then in step 275 the user targets avatars that meet relationship and/or attribute requirements by selecting appropriate menu buttons on the user's entertainment system, for example. The relationship and/or attribute requirements may include other users whose avatars are members of a team including the user's avatar, other users whose avatars belong to a community including the user's avatar, or other users whose avatars belong to the same game stage as the user's avatar. In step 280, the user's entertainment system sends relationship and/or attribute signals to game server 150 via communication network 140. Game server 150 receives the relationship and/or attribute signals, determines the other users whose avatars meet the specified relationships with the user's avatar and/or whose avatars match the specified attributes, and stores the other user names of the entertainment systems in memory of game server 150. The other user names of the entertainment systems are collectively referred to as distribution names. Finally, the distribution of the data to the entertainment systems associated with the distribution names is completed in steps 220-250 as described above.

According to the invention, data generated by application software played on an entertainment system may be distributed to the telephone devices. For example, data about a user's game status is distributed to the user's telephone device, or to other users whose avatars are within a specified range of the user's avatar in the virtual reality world, or to other users whose avatars have a virtual reality world relationship with the user's avatar or whose attributes match attributes specified by the user upon initialization of the user's entertainment system.

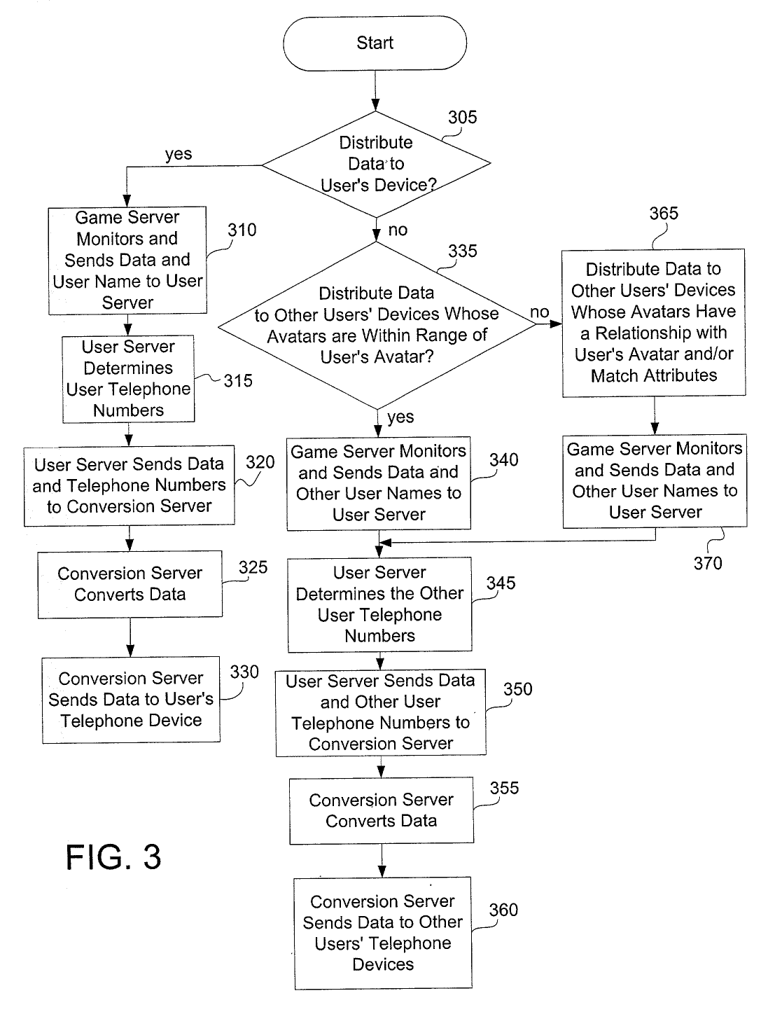

FIG. 3 is a flowchart of steps for distributing data from an entertainment system to the telephone devices, in accordance with one embodiment of the invention. First, in step 305, a user decides whether to initialize the application software to distribute data to the user's telephone device when a game situation is realized during user play. For example, game situations may include the user achieving points, the user achieving goals, the occurrence of game events, or when personal relationships to other users' avatars are altered during game play. If the user decides to distribute data to the user's telephone device, then in step 310 game server 150 monitors the game situation of user's entertainment system, and sends the user name (or the user ID) and digital data to user server 155 when the user's game situation is realized. In step 315, user server 155 access user database 160 and determines a user telephone number. In step 320, user server 155 sends the user telephone number and the digital data to conversion server 145. In step 325, conversion server 145 converts the digital data to analog data, and in step 330, sends the analog data to the user's telephone device. If the digital data is a digital voice signal, then conversion server 145 may synthesize an analog voice signal using a speech synthesizer, for example.

However, if in step 305, the user decides not to distribute the data to the user's telephone device, then in step 335 the user decides whether to distribute the data to other users' devices owned by other users whose avatars are within a specified range of the user's avatar. The specified range is chosen by the user upon initialization of the application software. If the user decides to distribute the data to other users whose avatars are within the specified range, then in step 340 game server 150 monitors the game situation of the user's entertainment system, and sends the digital data to user server 155 when the user's game situation is realized. In addition, game server 150 determines the other user names (or other user IDs) corresponding to the other users' avatars that are within the specified range of the user's avatar, and sends the other user names (or other user IDs) to user server 155. In step 345, user server 155 accesses user database 160 and determines the other user telephone numbers corresponding to the other user names (or other user IDs). In step 350, user server 155 sends the other user telephone numbers and the digital data to conversion server 145. In step 355, conversion server 145 converts the digital data to analog data, and in step 360, sends the analog data to each of the other users' telephone devices.

If, in step 335, the user decides not to distribute the data to other users' devices owned by other users whose avatars are within the specified range of the user's avatar, then in step 365 the user distributes the data to other users' devices owned by other users whose avatars have a virtual world relationship with the user's avatar and/or to other users' devices whose avatars match attributes specified by the user upon initialization of the application software. In step 370, game server 150 monitors the game situation of the user's entertainment system, and sends the digital data to user server 155 when the user's game situation is realized. In addition, game server 150 determines the other user names (or other user IDs) corresponding to the other users' avatars that have a relationship with the user's avatar, and/or determines the other user names (or other user IDs) whose avatars match attributes specified by the user, and sends the other user names (or other user IDs) to user server 155. Finally, the distribution of the data to the other users' telephone devices is completed in steps 345-360 as described above.

FIG. 4 is a block diagram of another embodiment of a networked electronic entertainment system 400 in accordance with the invention. System 400 includes, but is not limited to, a plurality of entertainment systems including an entertainment system A 105, an entertainment system B 110, and an entertainment system C 115, a plurality of IP telephone devices including an IP telephone device A 420, an IP telephone device B 425, and an IP telephone device C 430, a bi-directional communication network 140, a game server 150, a user management server 155, and a user database 160.

The telephone devices and the entertainment systems share communication network 140. For example, the user of telephone device A 420 associated with entertainment system A 105 sends data to the other entertainment systems via communication network 140 using VoIP technology. The data is digitized by telephone device A 420, and then sent to communication network 140 for distribution to the entertainment systems. Likewise, data may be distributed to the telephone devices. Upon receipt of digital entertainment system data from communication network 140, telephone device A 420 converts the digital data to analog data which is then received by the user of telephone device A 420.

The invention has been explained above with reference to several embodiments. Other embodiments will be apparent to those skilled in the art in light of this disclosure. For example, the present invention may readily be implemented using configurations other than those described in the embodiments above. Additionally, the present invention may effectively be used in conjunction with systems other than the embodiments described above. Therefore, these and other variations upon the embodiments are intended to be covered by the present invention, which is limited only by the appended claims.

What is claimed is:

1. A system for distributing data between telephone devices and entertainment systems, comprising:
a conversion server coupled to the telephone devices and the entertainment systems, the conversion server configured to receive the data and to enable communication between the telephone devices and the entertainment systems;
a game server communicatively coupled to the entertainment systems to monitor the entertainment systems and to store game information and the data; and
a user server communicatively coupled to the conversion server, the game server, and a user database to distribute the data.

2. The system of claim 1, wherein the user database includes user names, user IDs, and user telephone numbers.

3. The system of claim 2, wherein the game information includes the user names and target user names.

4. The system of claim 3, wherein the conversion server converts analog data received from the telephone devices to digital data.

5. The system of claim 4, wherein the conversion server inserts an identification in the header of the digital data.

6. The system of claim 5, wherein the identification is a user ID.

7. The system of claim 5, wherein the identification is a user's telephone number.

8. The system of claim 5, wherein the user server receives the digital data and accesses the user database to determine a user name associated with the identification.

9. The system of claim 8, wherein the user server sends a distribution request signal to the game server, the distribution request signal including the user name.

10. The system of claim 9, wherein the user server receives distribution names from the game server.

11. The system of claim 10, wherein the user server broadcasts the digital data to the entertainment systems associated with the distribution names.

12. The system of claim 11, wherein the digital data includes digital voice signals and digital image data.

13. The system of claim 10, wherein the user server prepares a distribution list including the distribution names and sends the distribution list and the digital data to the game server.

14. The system of claim 13, wherein the game server broadcasts the digital data to the entertainment systems associated with the distribution names in the distribution list.

15. The system of claim 14, wherein the digital data includes digital voice signals and digital image data.

16. The system of claim 10, wherein the distribution names include the target user names associated with the user name, the target user names selected by the user.

17. The system of claim 16, wherein the user of one of the entertainment systems selects the target user names from a menu on the one of the entertainment systems.

18. The system of claim 16, wherein the user of one of the entertainment systems chooses the target user names by selecting target user avatars that are displayed on the one of the entertainment systems.

19. The system of claim 16, wherein the user of one of the entertainment systems chooses the target user names whose avatars are within a specified range of the user's avatar.

20. The system of claim 16, wherein the user of one of the entertainment systems chooses the target user names whose avatars have relationships with the user's avatar.

21. The system of claim 16, wherein the user of one of the entertainment systems chooses the target user names whose avatars have specified attributes.

22. The system of claim 3, wherein the game server sends each user's entertainment system data and each user's name to the user server when each user's game situations are realized.

23. The system of claim 22, wherein one of the game situations is a user achieving goals.

24. The system of claim 22, wherein one of the game situations is an occurrence of game events.

25. The system of claim 22, wherein one of the game situations is an alteration of relationships between a user's avatar and other users' avatars.

26. The system of claim 22, wherein the user server accesses the user database, determines a user telephone number associated with each received user name, and sends each user's entertainment system data and each user's telephone number to the conversion server.

27. The system of claim 26, wherein the conversion server converts each user's entertainment system data to analog data and sends the analog data to each user's telephone device.

28. The system of claim 26, wherein if a user's entertainment system data is voice data, the conversion server synthesizes an analog voice signal and sends the analog voice signal to the user's telephone device.

29. A method for distributing data between telephone devices and entertainment systems, comprising the steps of:
receiving data from one of the telephone devices;
enabling communication between the telephone devices and the entertainment systems;
monitoring the entertainment systems and storing game information and entertainment system data; and
distributing the data.

30. The method of claim 29, further comprising the step of converting analog data to digital data.

31. The method of claim 29, further comprising the step of inserting an identification in the data.

32. The method of claim 31, further comprising the step of determining a user name associated with the identification in the data.

33. The method of claim 32, further comprising the step of determining target user names associated with the user name.

34. The method of claim 33, further comprising the step of broadcasting the data to the entertainment systems associated with the target user names.

35. The method of claim 33, further comprising the step of choosing the target user names from a menu on the user's entertainment system.

36. The method of claim 33 further comprising the step of choosing the target user names by selecting target user avatars that are displayed on the user's entertainment system.

37. The method of claim 33, further comprising the step of choosing the target user names whose avatars are within a specified range of the user's avatar.

38. The method of claim 33, further comprising the step of choosing the target user names whose avatars have relationships with the user's avatar.

39. The method of claim 33, further comprising the step of choosing the target user names whose avatars have specified attributes.

40. The method of claim 29, further comprising the step of determining a telephone number associated with a user of an entertainment system user's name when a user game situation is realized.

41. The method of claim 40, further comprising the step of converting the entertainment system data associated with the user's name to analog entertainment system data and sending the analog entertainment system data to the user's telephone device.

42. The method of claim 40, further comprising the step of synthesizing an analog voice signal from the entertainment system data associated with the user's name and sending the analog voice signal to the user's telephone device if the entertainment system data is a digital voice signal.

43. A method for distributing data between a telephone network and electronic entertainment systems, comprising the steps of:
transmitting data to a conversion server via the telephone network;
routing the data to a user management server via a communication network;
accessing a user database for a user name;
accessing a game server for distribution names associated with the user name; and
sending the data to the electronic entertainment systems associated with the distribution names.

44. A system for distributing data between a telephone network and electronic entertainment systems, comprising:
means for transmitting data to a conversion server via the telephone network;
means for routing the data to a user management server via a communication network;
means for accessing a user database for a user name;
means for accessing a game server for distribution names associated with the user name; and
means for sending the data to the electronic entertainment systems associated with the distribution names.

45. A method for distributing data between telephone devices and electronic entertainment systems, comprising the steps of:
transmitting data and target user names from an entertainment system to a game server via a communication network when game situations are realized;
routing the data and the target user names to a user management server via the communication network;
accessing a user database for target user telephone numbers; and
sending the data to telephone devices associated with the target user telephone numbers.

46. A system for distributing data between telephone devices and electronic entertainment systems, comprising:
means for transmitting data and target user names from an entertainment system to a game server via a communication network when game situations are realized;
means for routing the data and the target user names to a user management server via the communication network;
means for accessing a user database for target user telephone numbers; and
means for sending the data to telephone devices associated with the target user telephone numbers.
